(19) United States
(12) Patent Application Publication
(10) Pub. No.: US 2011/0299708 A1
(43) Pub. Date: Dec. 8, 2011

(54) METHOD OF FORMING A CONNECTOR FOR A HEARING AID

(75) Inventors: Martin Bondo, Vaerlose (DK); Gerner Kurt Soelberg Pedersen, Lille Skensved (DK)

(73) Assignee: Sonion A/S, Roskilde (DK)

(21) Appl. No.: 13/154,988

(22) Filed: Jun. 7, 2011

Related U.S. Application Data
(60) Provisional application No. 61/352,188, filed on Jun. 7, 2010.

(51) Int. Cl. H04R 25/00; H01R 43/20; H01R 24/00

(52) U.S. Cl. 381/312; 439/660; 29/876

(57) ABSTRACT

A method of forming a connector for a hearing aid, by providing a plug, a receiver housing and an interconnecting tube; providing or arranging one or more accommodated elements in the interconnecting tube, and elongating the interconnecting tube by forcing the first and the second ends of the interconnecting elements away from each other whereby a length of the interconnecting element is increased. A connector for a hearing aid, the connector comprising a plug and a receiver housing interconnected by an interconnecting tube, wherein the width of the interconnecting tube is below 3 mm and wherein at least four electrical conductors are arranged in the interconnecting tube such that the electrical conductors co-extend with the interconnecting tube.

### REFERENCE TO RELATED APPLICATIONS

This application claims the benefit of U.S. Provisional Patent Application Ser. No. 61/352,188, filed Jun. 7, 2010, and titled “A Method of Forming a Connector for a Hearing Aid,” which is incorporated herein by reference in its entirety.

### FIELD OF THE INVENTION

The present invention relates to method of forming a connector for a hearing aid. Moreover, the present invention relates to a connector for a hearing aid.

### BRIEF SUMMARY

In a first aspect the present invention relates to a method of forming a connector for a hearing aid, the connector comprising a plug and a receiver housing interconnected by an interconnecting tube, the interconnecting tube, defining a first end and a second end, and accommodating one or more accommodated elements, the method comprising providing the plug, the receiver housing and the interconnecting tube, providing the one or more accommodated elements in the interconnecting tube, and elongating the interconnecting tube by forcing the first and the second ends of the interconnecting elements away from each other whereby a length of the interconnecting element is increased.

It will be appreciated that by elongating the interconnecting element, the length of the element will increase and the width will decrease. Thus, the interconnecting element is wider prior to its elongation than before its elongation. It will be appreciated that it is easier to provide/accommodate the accommodated elements inside the interconnecting tube while it is wide, relative to when it is slim. Thus, the present invention provides a method which allows for a larger number of accommodated elements to be provided inside the interconnecting tube. Moreover, the present invention makes it possible to arrange the accommodated elements in a predetermined way inside the interconnection element.

In relation to a first aspect of the invention, the term “accommodated elements” shall designate any element which, subsequently to performing the method according to the first aspect, is accommodated in the interconnecting tube. However the skilled person will readily realize that prior to arranging the elements in the interconnecting tube the elements are not accommodated in the tube. However, the term “accommodated elements” shall designate such elements prior to, during, and subsequent to the elongation process.

In an embodiment, the accommodated elements may comprise one or more of an electrical conductor, a passive electrical component, an active electrical component, an electrical circuit, a reinforcing element, a tube forming a passage and an optical wave guide.

The electrical conductor may comprise a conducting element such as a metal material which may be covered with an electrically insulating material. In an embodiment, at least one electrical conductor is provided, such as at least two or three or four or five or six or seven or eight or nine or ten or eleven or twelve or thirteen or fourteen or fifteen.

In the context of the present invention the term “active electrical components” shall be understood as components which require electrical power to operate in addition to the power supplied by the input signal(s). Similarly, “passive electrical components” shall designate components which do not require electrical power to operate in addition to the power supplied by the input signal(s).

Examples of electrical components are switches, resistors, fuses, current limiters, capacitors, inductors, piezoelectric devices, switches, relays, semiconductors, speakers, microphones, power sources such as batteries, transducers, sensors/detectors, diodes, LEDs (light emitting diodes), transistors, integrated circuits and optoelectric components.

The electrical circuits may comprise one or more of the above electrical components. The circuit may be an analogue and/or a digital circuit. In the context of the present invention the term “circuit” shall be understood as a plurality of individual electronic components e.g. one or more of the abovementioned, which are electrically connected such that an electrical current and/or voltage may flow through the components.

In an embodiment, a reinforcing element is secured to the ends of the interconnecting element after elongation of the element. Alternatively or as a supplement, the reinforcing element may be secured to the plug and/or receiver housing. The reinforcing element may be adapted to reinforce the interconnecting tube such that a larger axial force may be applied to the interconnecting tube without causing damage to the accommodated elements and/or the interconnecting tube. Additionally, the reinforcing element may be adapted to reinforce the interconnecting tube and the plug and receiver housing, such that a larger axial force may be applied between the plug and receiver housing without causing damage to the accommodated elements and/or the interconnecting tube and/or the plug and/or the receiver housing. By causing damage may be in an embodiment be understood that one or more of the accommodated elements, the interconnecting tube, the plug and the receiver housing ceases to function permanently or periodically.

In an embodiment, the reinforcing element is adapted to protect the inside of the interconnecting tube from being damaged by an external application of pressure or hits to an outer surface of the interconnecting element.

In an embodiment, at least one reinforcing element is provided, such as one or two, or three, or four, or five, or six. At least one of the reinforcing elements may form a solid wire, a braided wire, a sheath such as a braided sheath.

The plug and the receiver housing may comprise one or more electrical terminals which are electrically connected to an accommodated element, e.g. an electrical element forming an electrical conductor inside the interconnecting element. Thus, one electrical terminal of the plug may be electrically connected to a terminal of the receiver housing.

In an embodiment, at least one tube is accommodated inside the interconnecting tube, such as two, or three, or five.

During use of the connector, the accommodated tube may serve as a sound/audio canal through which sound may propagate, e.g. from a behind-the-ear unit to an in-the-ear unit.

In an embodiment, the plug and/or the receiver housing are attached to the interconnecting element, e.g. by means of an adhesive or welding. In another embodiment, the interconnecting tube and the plug and receiver housing form a monolithic element, i.e. forming one element with out seams.

The interconnecting tube and the plugs may comprise the same material or different materials. The interconnecting element and/or the plug and/or the receiver housing may comprise one or more of the following materials: an acrylic material, polypropylene, Arcylonitrile Butadiene Styrene (ABS), poly propylene (PP), polyethylene (PE), poly Carbonate (PC), polystyrene (PS), polytetrafluoroethylene (PTFE), Polyvinyl chloride (PVC), Polyoxymethylene (POM), Polymethyl methacrylate (PMMA), and a natural or synthetic rubber material.

As previously mentioned, the method, according to the first aspect, comprises providing the plug, the receiver housing and the interconnecting tube, providing the one or more accommodated elements in the interconnecting tube, and elongating the interconnecting tube by forcing the first and the second ends of the interconnecting elements away from each other whereby the length of the interconnecting element is increased with out changing the length of the accommodated elements.

In an embodiment, the interconnecting tube is elongated by forcing its first and second ends away from each other. This may be done by securing a tool to an outer surface of each end of the interconnecting tube and forcing the tools away from each other.

In an embodiment, the step of elongating the interconnecting tube comprises forcing the plug and the receiver housing away from each other so as to force the first and second ends of the interconnecting element away from each other whereby a length of the interconnecting element is increased. In the latter embodiment, the forcing the plug and the receiver housing away from each may be carried out by means of predetermined tools, which are adapted to engage surfaces of the plug and receiver housing during the movement away from each other.

Moreover, the method may further comprise terminating the step of elongating the interconnecting element when a predetermined (axial) tension in the interconnecting tube has been achieved. In an embodiment, the elongating the interconnecting element is terminated when the tension is at least 50 percent of the tension needed to break the interconnecting tube, such as 50 percent, such as 60 percent, such as 70 percent, such as 80 percent, such as 90 percent, such as 95 percent. In an embodiment, the tension is a tension above the elastic limit of the interconnecting tube. By elastic limit shall be understood such that a tension above the elastic limit will cause permanent deformation (elongation) of the elongated tube.

In an embodiment, the method further comprises terminating the step of elongating the interconnecting element when a predetermined friction between the interconnecting tube and the accommodated elements has been achieved. The predetermined friction may be the level of friction which prevents the accommodated components from moving relative to the interconnecting tube, during elongation of the interconnecting tube.

In an embodiment, the elongating the interconnecting element causes the width of the interconnecting tube to decrease. At the same time, the method further comprises terminating the elongating the interconnecting element when a predetermined width of the interconnecting element has been achieved. In an embodiment, the predetermined width is a width that is 10 percent larger than a total width of the accommodated elements, such as 20 percent larger. “Total width” shall be understood to refer to the smallest possible width achievable when providing the accommodated elements next to each other. In an embodiment, the predetermined width is a width that prevents the accommodated elements provided inside the interconnecting tube from moving relative to each other in a direction transverse to the longitudinal direction of the interconnecting tube.

In an embodiment, the method further comprises providing a friction reducing agent to an inner surface of the interconnecting tube and/or to an outer surface of one or more of the accommodated elements so as to reduce the friction between the interconnecting tube and the accommodated elements during elongation of the interconnecting tube. By providing a friction reducing agent, it may be possible to stretch the interconnecting tube even further without causing the interconnecting tube to break. The friction reducing agent may be one or more of oil, silicone, PTFE, for example.

In some embodiments, the temperature of neither the plug and the receiver housing and the interconnecting tube is elevated in connection with the method according to aspects of the present invention. In other embodiments, the method further comprises elevating the temperature of the interconnecting element and of accommodated elements.

The elevating the temperature may be performed prior to the elongating the interconnecting tube and/or simultaneously with the latter act/step and/or subsequently to the latter act/step.

In a second aspect, the present invention relates to a connector for a hearing aid, the connector comprising a plug and a receiver housing interconnected by an interconnecting tube, wherein the width of the interconnecting tube is below five mm and wherein at least four electrical conductors are arranged in the interconnecting tube such that the electrical conductors co-extend with the interconnecting tube.

The width of the interconnecting tube may be below 5 mm or below 5 mm or below 3 mm or below 2 mm or below 1 mm or below 0.5 mm or below 0.3 mm or below 0.1 mm.

In an embodiment, the connector comprises at least 4 electrical conductors, such as 5 conductors, such as 6 conductors, such as 7 conductors, such as 8 conductors, such as 9 conductors, such as 10 conductors, such as 11 conductors, such as 12 conductors, such as 13 conductors, such as 14 conductors, such as 15 conductors.

In an embodiment, the interconnecting tube further accommodates one or more of an electrical component, an electrical circuit, a reinforcing element and a tube forming an audio passage and an optical wave guide.

The invention according to a second aspect may comprise any combination of features and elements of the invention according to the first aspect. As an example the description of the accommodated elements under the first aspect of the invention also applies to the invention according to the second aspect.

In a third aspect, the present invention relates to a hearing aid comprising the connector according to the second aspect of the invention.

In a fourth aspect, the present invention relates to a connector manufactured by means of the method according to first aspect of the invention.

### BRIEF DESCRIPTION OF THE FIGURES

The invention will now be described in further detail with relation to the figures in which:

FIG. 1 discloses the connector prior to elongation,

FIG. 2 discloses the receiver housing after elongation,

FIG. 3 discloses the connector after an elongation process,

FIG. 4a discloses the geometry of the interconnecting tube prior to elongation, and

FIG. 4b discloses the geometry of the interconnecting tube after the elongation.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the scope of the invention as defined by the appended claims.

### DETAILED DESCRIPTION OF THE FIGURES

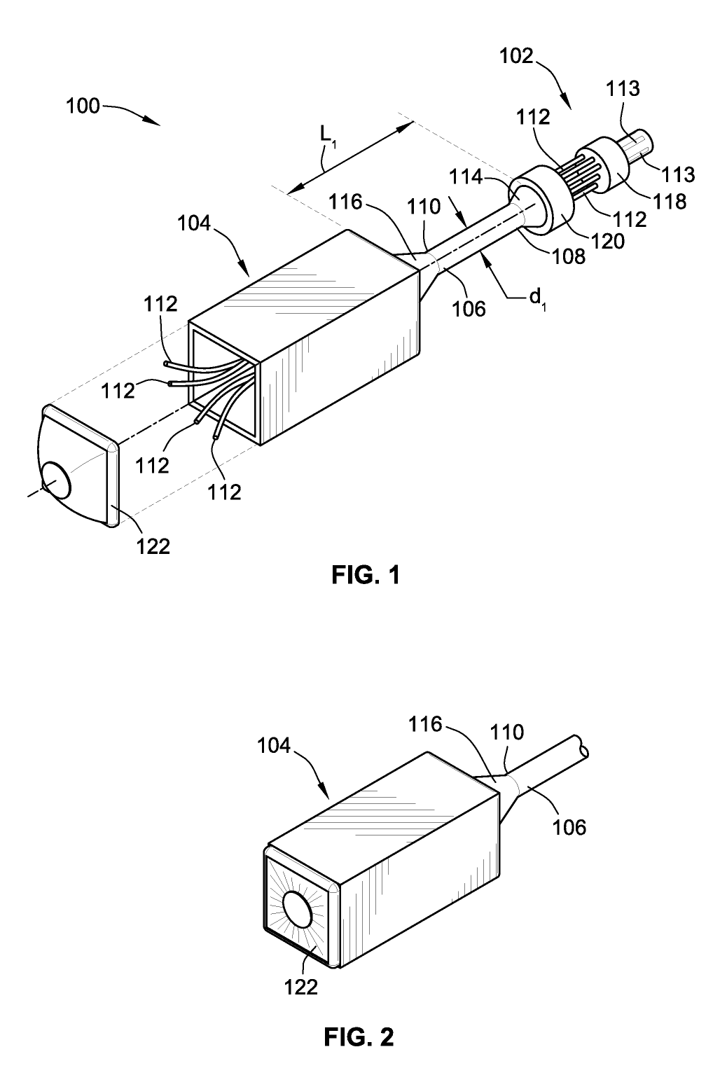

FIG. 1 discloses a connector 100 for a hearing aid (not disclosed). The connector 100 comprises a plug 102, a receiver housing 104, and an interconnecting tube 106. The interconnecting tube 106 defines a first end 108 and a second end 110, and accommodates one or more accommodated elements 112. In the embodiment of FIG. 1, the accommodated elements 112 are provided in the form of electrical conductors. However, it will be appreciated that the accommodated elements may be any one of those mentioned under the first aspect of the invention. In the embodiment of FIG. 1, the interconnecting tube 106 is attached to the plug 102 and the receiver housing 104, e.g. by means of welding.

Initially the interconnecting tube 106, the plug 102, and the receiver housing 104 are provided. Subsequently, the accommodated elements 112 are inserted into the interconnecting tube 106, which is relatively wide, as it has not been elongated yet. In an embodiment, the accommodated elements 112 are electrically connected to the terminals 113, prior to insertion of the accommodated elements 112 into the interconnecting tube 106. In another embodiment, the terminals 113 are electrically (and physically) connected to the accommodated elements 112 after these elements 112 have been inserted into the interconnecting tube 106.

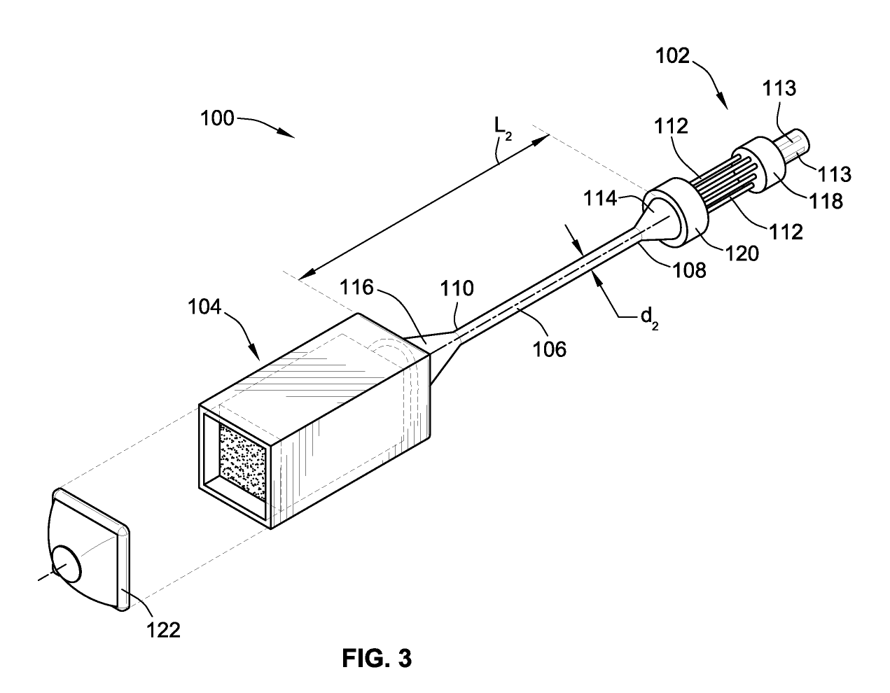

In the next step of the process, the first end 108 and the second end 110 are forced in opposite directions, i.e. away from each other. This may be done by means of a tool that is adapted to abut the first inclined surface 114 and the second inclined surface 116, during application of the oppositely directed forces. This will cause the interconnecting tube 106 to be elongated, whereby the diameter of the interconnecting tube 106 decreases. The interconnecting tube 106 is shown in its elongated form in FIG. 3.

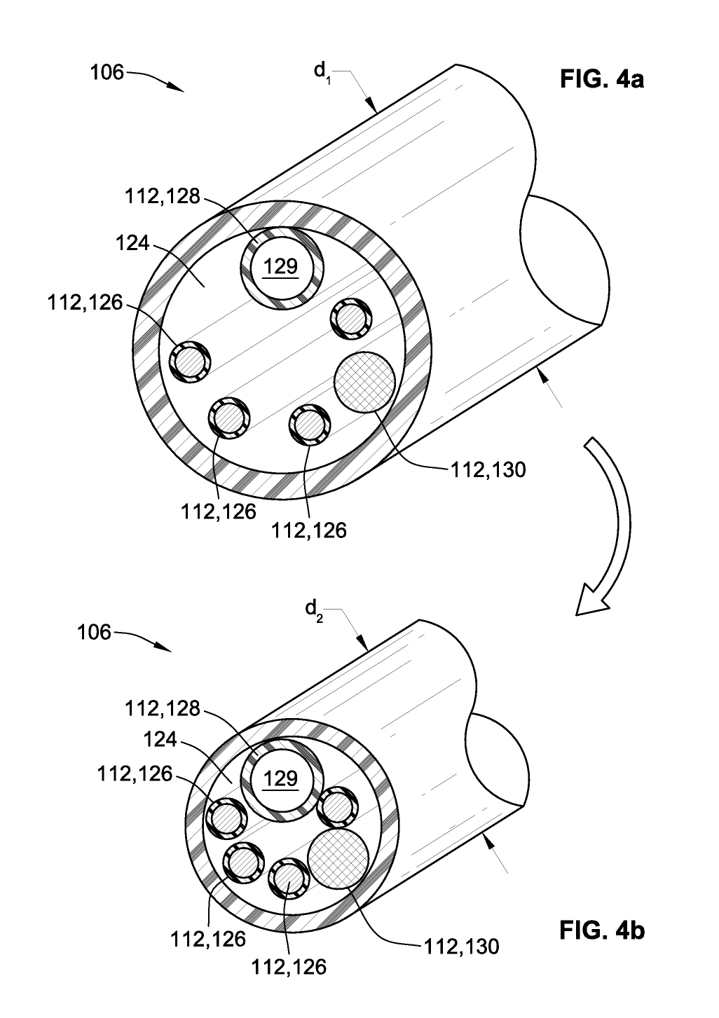

Prior to the elongation process, the interconnecting tube 106 has a length L1 and a diameter d1, see FIG. 1. Subsequently to the elongation process, the interconnecting tube 106 is longer and has a length L2. At the same time the width of the interconnecting tube 106 is smaller, as the interconnecting tube 106 now has the diameter d2. It will be appreciated that L2 is larger (longer) than L1 and that d1 is larger (wider) than d2. The different diameters are discussed in further detail in relation to FIGS. 4a and 4b.

In an embodiment, the tools are adapted to abut each of the plug 102 and the receiver housing 104 during the elongation process.

Due to the abutment between the collar 118 and the collar 120, the accommodated elements 112 are prevented from being pulled into the interconnecting tube 106 during the elongation process. Instead, the other end of the accommodated elements 112 are pulled into the interconnecting tube 106. Thus, it is desirable that the accommodated elements 112 in the opposite end are sufficiently long to ensure that at least a part of the accommodated elements 112 extend out of the receiver housing 104, both before and after the elongation process.

After the elongation process, end element 122 defining one or more terminals (not shown) is fastened to the receiver housing 104, see FIG. 2. However prior to this fastening process, the accommodated elements 112 are (electrically) connected to the terminals (not shown).

FIGS. 4a and 4b discloses a cross-section of the interconnecting tube 106 prior to the elongation (FIG. 4a) and after elongation (FIG. 4b). Evidently, the width d1 of the interconnecting tube 106 in FIG. 4a is larger than the width d2 in FIG. 4b. In other words, the interconnecting tube 106 is wider prior to elongation than after elongation. As the interconnecting tube 106 is wider prior to elongation, the inner space 124 is larger before elongation. Accordingly, it is easier to insert the accommodated elements 112 into the inner space 124. In the embodiment, the accommodated elements 112 are provided in the form of electrical conductors 126, a tube 128 forming a passage 129, and a reinforcing element 130.

The electrical conductors 126 may be electrically connected to the terminals of the plug 102 and the receiver housing 104. The tube 128 forming a passage 129 may be used as an audio/sound canal through which sound propagates during use of the connector 100. The reinforcing element 130 may serve the purpose of axially reinforcing the connector 100, such that it may withstand a larger axial force without breaking.

Each of these embodiments and obvious variations thereof is contemplated as falling within the scope of the claimed invention, which is set forth in the following claims.

What is claimed is:

1. A method of forming a connector for a hearing aid, the connector comprising
a plug and
a receiver housing interconnected by
an interconnecting tube, the interconnecting tube:
defining a first end and a second end, and
accommodating one or more accommodated elements;
the method comprising:
providing the plug, the receiver housing, and the interconnecting tube;
providing the one or more accommodated elements in the interconnecting tube; and
elongating the interconnecting tube by forcing the first and the second ends of the interconnecting elements away from each other whereby a length of the interconnecting element is increased.

2. The method according to claim 1, wherein the elongating the interconnecting tube comprises forcing the plug and the receiver housing away from each other so as to force the first and second ends of the interconnecting element away from each other whereby the length of the interconnecting element is increased.

3. The method according to claim 1, further comprising terminating the elongating the interconnecting element when a predetermined tension in the interconnecting tube has been achieved.

4. The method according to claim 1, further comprising terminating the elongating the interconnecting element when a predetermined friction between the interconnecting tube and the accommodated elements has been achieved.

5. The method according to claim 1, wherein the elongating the interconnecting element causes a width of the interconnecting tube to decrease, the method further comprising terminating the elongating the interconnecting element when a predetermined width of the interconnecting element has been achieved.

6. The method according to claim 1, further comprising providing a friction reducing agent to an inner surface of the interconnecting tube and/or to an outer surface of one or more of the accommodated elements so as to reduce the friction between the interconnecting tube and the accommodated elements during elongation of the interconnecting tube.

7. The method according to claim 1, further comprising elevating the temperature of the interconnecting element and of accommodated elements.

8. The method according to claim 1, wherein the accommodated elements comprises one or more of an electrical conductor, a passive electrical component, an active electrical component, an electrical circuit, a reinforcing element, a tube forming a passage, and an optical wave guide.

9. A connector for a hearing aid, the connector comprising a plug and a receiver housing interconnected by an interconnecting tube, wherein the width of the interconnecting tube is below 3 mm and wherein at least four electrical conductors are arranged in the interconnecting tube such that the electrical conductors co-extend with the interconnecting tube.

10. The connector according to claim 9, wherein the interconnecting tube further accommodates one or more of an electrical component, an electrical circuit, a reinforcing element and a tube forming an passage.

11. The connector according to claim 9 in combination with a hearing aid.

12. The connector according to claim 10 in combination with a hearing aid.

13. A connector manufactured by a method of forming a connector for a hearing aid, the connector comprising
a plug and
a receiver housing interconnected by
an interconnecting tube, the interconnecting tube:
defining a first end and a second end, and
accommodating one or more accommodated elements;
the method comprising:
providing the plug, the receiver housing, and the interconnecting tube;
providing the one or more accommodated elements in the interconnecting tube; and
elongating the interconnecting tube by forcing the first and the second ends of the interconnecting elements away from each other whereby a length of the interconnecting element is increased.
